SEQUENCE LISTING (5 sequences)

SEQ ID NO: 1 - protein, 185 aa, Homo sapiens
MKLVSVALMYLGSLAFLGADTARLDVASEFRKKWNKWALSRGKRELRMSSSYPTGLADVKAGPAQTLIRPQDMKGASRSPEDSSPDAARIRVKRYRQSMNNFQGLRSFGCRFGTCTVQKLAHQIYQFTDKDKDNVAPRSKISPQGYGRRRRRSLPEAGPGRTLVSSKPQAHGAPAPPSGSAPHFL

SEQ ID NO: 2 - protein, 164 aa, Homo sapiens
ARLDVASEFRKKWNKWALSRGKRELRMSSSYPTGLADVKAGPAQTLIRPQDMKGASRSPEDSSPDAARIRVKRYRQSMNNFQGLRSFGCRFGTCTVQKLAHQIYQFTDKDKDNVAPRSKISPQGYGRRRRRSLPEAGPGRTLVSSKPQAHGAPAPPSGSAPHFL

SEQ ID NO: 3 - protein, 20 aa, Homo sapiens
ARLDVASEFRKKWNKWALSR

SEQ ID NO: 4 - protein, 40 aa, Homo sapiens
ELRMSSSYPTGLADVKAGPAQTLIRPQDMKGASRSPEDSS

SEQ ID NO: 5 - protein, 52 aa, Homo sapiens
YRQSMNNFQGLRSFGCRFGTCTVQKLAHQIYQFTDKDKDNVAPRSKISPQGY

(19) United States
(12) Patent Application Publication
(10) Pub. No.: US 2012/0003751 A1
(43) Pub. Date: Jan. 5, 2012

(54) BIOMARKER FOR THE PREDICTION OF FIRST ADVERSE EVENTS

(75) Inventors: Andreas Bergmann, Berlin (DE); Joachim Struck, Berlin (DE); Olle Melander, Malmo (SE); Christopher Newton-Cheh, Boston, MA (US); Thomas J. Wang, Boston, MA (US)

(73) Assignee: B.R.A.H.M.S. GMBH, HENNIGSDORF (DE)

(21) Appl. No.: 13/122,822

(22) PCT Filed: Oct. 7, 2009
(86) PCT No.: PCT/EP09/07301

§ 371 Date: Sep. 22, 2011

(30) Foreign Application Priority Data
Oct. 7, 2008 (EP) 08166038.3

(51) Int. Cl. G01N 21/76

(52) U.S. Cl. 436/501

(57) ABSTRACT

Subject of the present invention are assays and in vitro methods for the prediction of first coronary and cardiovascular events and biomarkers useful therein.

The present invention concerns the prediction of a first adverse event in subjects, diagnostic assays and their uses.

Effective cardiovascular prevention relies on the accurate identification of individuals at risk, but cardiovascular events frequently occur in individuals with a low burden of traditional risk factors (Khot U N, et al.: Prevalence of conventional risk factors in patients with coronary heart disease. JAMA. 2003; 290:898-904). As a result, the potential use of circulating biomarkers to augment conventional risk assessment has attracted increasing attention in recent years. However, prior studies have reached differing conclusions regarding the utility of biomarkers for cardiovascular risk prediction. Some reports indicate that biomarkers such as C-reactive protein (CRP) and N-terminal pro-B-type natriuretic peptide (NT-proBNP) aid risk prediction (Ridker P M, et al.: Development and validation of improved algorithms for the assessment of global cardiovascular risk in women: the Reynolds Risk Score. JAMA. 2007; 297:611-619; Zethelius B, et al.: Use of multiple biomarkers to improve the prediction of death from cardiovascular causes. N Engl J Med. 2008; 358:2107-2116), whereas other studies conclude that such biomarkers contribute relatively little incremental information (Folsom A R, et al.: An assessment of incremental coronary risk prediction using C-reactive protein and other novel risk markers: the atherosclerosis risk in communities study. Arch Intern Med. 2006; 166:1368-1373; Wang T J, et al.: Multiple biomarkers for the prediction of first major cardiovascular events and death. N Engl J Med. 2006; 355:2631-2639).

A number of factors influence how well biomarkers predict outcomes, including the population studied and the specific biomarkers selected. Studies focusing on elderly or high-risk populations often yield favourable estimates of biomarker performance (Zethelius B, et al.: Use of multiple biomarkers to improve the prediction of death from cardiovascular causes. N Engl J Med. 2008; 358:2107-2116; Blankenberg S, et al.: Comparative impact of multiple biomarkers and N-Terminal pro-brain natriuretic peptide in the context of conventional risk factors for the prediction of recurrent cardiovascular events in the Heart Outcomes Prevention Evaluation (HOPE) Study. Circulation. 2006; 114:201-208), but the greatest need for new risk markers exists in low to intermediate-risk populations, for which the data are most conflicting (de Lemos J A, Lloyd-Jones D M: Multiple biomarker panels for cardiovascular risk assessment. N Engl J Med. 2008; 358:2172-2174). With regard to the statistical criteria for evaluating new biomarkers, it is widely accepted that basic association measures such as hazards ratios or odds ratios are insufficient to assess prognostic utility, but there is debate over what measures to use (Cook N R.: Use and misuse of the receiver operating characteristic curve in risk prediction. Circulation. 2007; 115:928-935). Newer metrics assess how well biomarkers assign patients to clinical risk categories (Ridker P M, et al.: Development and validation of improved algorithms for the assessment of global cardiovascular risk in women: the Reynolds Risk Score. JAMA. 2007; 297:611-619; Pencina M J, et al.: Evaluating the added predictive ability of a new marker: from area under the ROC curve to reclassification and beyond. Stat Med. 2008; 27:157-172), but only a few studies have incorporated such metrics (Zethelius B, et al.: Use of multiple biomarkers to improve the prediction of death from cardiovascular causes. N Engl J Med. 2008; 358:2107-2116). Another important consideration is the selection of biomarkers. Although several biomarkers consistently predict cardiovascular events after adjustment for traditional risk factors (Vasan R S.: Biomarkers of cardiovascular disease: molecular basis and practical considerations. Circulation. 2006; 113:2335-2362), few primary prevention studies have incorporated multiple informative biomarkers simultaneously, an approach that has the greatest prospect of providing incremental information (de Lemos J A, Lloyd-Jones D M: Multiple biomarker panels for cardiovascular risk assessment. N Engl J Med. 2008; 358:2172-2174).

The peptide Adrenomedullin (ADM) was first described in 1993 (Kitamura et al. (1993), Biochem. Biophys. Res. Commun 192:553-560) as a novel hypotensive peptide comprising 52 amino acids, which had been isolated from a human pheochromocytoma. In the same year, cDNA coding for a precursor peptide comprising 185 amino acids and the complete amino acid sequence of this precursor peptide were also described (Kitamura et al. (1993), Biochem. Biophys. Res. Commun 194:720-725). The precursor peptide, which comprises, inter alia, a signal sequence of 21 amino acids at the N-terminus, is referred to as “pre-pro-Adrenomedullin” (pre-pro-ADM).

The ADM peptide comprises amino acids 95 to 146 of pre-pro-ADM, from which it is formed by proteolytic cleavage. Some peptide fragments of those formed in the cleavage of the pre-proADM have been characterized in detail, in particular the physiologically active peptides adrenomedullin (ADM) and “PAMP”, a peptide comprising 20 amino acids (22-41) which follow the 21 amino acids of the signal peptide in pre-Pro-ADM. Another fragment of unknown function and high ex vivo stability is midregional proAdrenomedullin (MR-proADM) (Struck et al. (2004), Peptides 25(8):1369-72), for which a reliable quantification method has been developed (Morgenthaler et al. (2005), Clin. Chem. 51(10):1823-9).

The discovery and characterization of ADM in 1993 triggered intensive research activity and a flood of publications, the results of which have recently been summarized in various review articles, in the context of the present description, reference is being made in particular to the articles to be found in an issue of “Peptides” devoted to ADM (Peptides 22 (2001)), in particular (Takahashi (2001), Peptides 22, 1691 and Eto (2001), Peptides 22, 1693-1711). The subject is further reviewed in Hinson et al. (Hinson et al. (2000), Endocr. Rev. 21 (2), 138-167). ADM may be regarded as a polyfunctional regulatory peptide. It is released into the circulation in an inactive form extended by a C-terminal glycine (Kitamura et al. (1998), Biochem. Biophys. Res. Commun 244 (2), 551-555).

ADM is an effective vasodilator. The hypotensive effect has been associated particularly with peptide segments in the C-terminal part of ADM. Peptide sequences of the N-terminus of ADM on the other hand exhibit hypertensive effects (Kitamura et al. (2001), Peptides 22, 1713-1718).

Subject of the present invention is a method for predicting a first adverse event in a subject or identifying a subject having an enhanced risk for getting a first adverse event and uses of assays and capture probes therefore.

Subject of the present invention is a method for predicting the risk of getting an adverse event in a healthy subject or identifying a healthy subject having an enhanced risk for getting an adverse event comprising:
determining the level of Pro-Adrenomedullin or fragments thereof, in a sample obtained from said subject; and
using said level of Pro-Adrenomedullin or fragments thereof alone or in conjunction with other prognostic clinical and/or laboratory parameters for the prediction of a first adverse event or inferring from it a risk for getting an adverse event.

In one particular embodiment this adverse event may be the first which has ever been diagnosed for this subject. In one case a first event may be a e.g. coronary event which means that this subject has never had before a coronary event. In a preferred embodiment of the invention the risk of getting a first adverse event is predicted and a subject is identified which has an advanced risk for getting a first adverse event.

In the context of the present invention, the term “Pro-Adrenomedullin” and the term “Pro-Adrenomedullin or fragments thereof” refer to either the entire molecule of Pro-Adrenomedullin or fragments thereof of at least 12 amino acids including but not limited to Adrenomedullin, PAMP and MR-proADM. In a preferred embodiment, pro-Adrenomedullin refers to either the entire molecule of Pro-Adrenomedullin or fragments thereof of at least 12 amino acids with the exception of mature Adrenomedullin. In a further preferred embodiment, pro-Adrenomedullin refers to either the entire molecule of Pro-Adrenomedullin or fragments thereof of at least 12 amino acids with the exception of mature Adrenomedullin or fragments of mature Adrenomedullin Thus, in one particular embodiment of the invention “determining the level of Pro-Adrenomedullin or fragments thereof” refers to determining the level of Pro-Adrenomedullin or fragments thereof, wherein the level of mature Adrenomedullin and/or fragments of mature Adrenomedullin is not determined.

The amino acid sequence of the precursor peptide of Adrenomedullin (pre-pro-Adrenomedullin) is given in FIG. 1 (SEQ ID NO:1). Pro-Adrenomedullin relates to amino acid residues 22 to 185 of the sequence of pre-pro-Adrenomedullin. The amino acid sequence of pro-Adrenomedullin (pro-ADM) is given in FIG. 2 (SEQ ID NO:2). The pro-ADM N-terminal 20 peptide (PAMP) relates to amino acid residues 22-41 of pre-pro-ADM. The amino acid sequence of PAMP is given in FIG. 3 (SEQ ID NO:3). MR-pro-Adrenomedullin (MR-pro-ADM) relates to amino acid residues 45-92 of pre-pro-ADM. The amino acid sequence of MR-pro-ADM is provided in FIG. 4 (SEQ ID NO:4). The amino acid sequence of mature Adrenomedullin (ADM) is given in FIG. 5 (SEQ ID NO:5).

As mentioned herein in the context of proteins or peptides, the term “fragment” refers to smaller proteins or peptides derivable from larger proteins or peptides, which hence comprise a partial sequence of the larger protein or peptide. Said fragments are derivable from the larger proteins or peptides by saponification of one or more of its peptide bonds.

In the context of the present invention, the term “level” in expressions such as “level of a protease”, “analyte level” and similar expressions, refers to the quantity of the molecular entity mentioned in the respective context, or in the case of enzymes it can also refer to the enzyme activity.

An adverse event is defined as an event compromising the health of an individual.

Said adverse event is not restricted to but may be selected from the group comprising a coronary event, cardiovascular event, death, heart failure, diabetes, hypertension. The term “diabetes” in the context of this invention is diabetes mellitus unless otherwise stated. Preferably, diabetes mellitus is type 1 diabetes mellitus or type 2 diabetes mellitus. Preferably herein, the first adverse event is a first coronary event or a first cardiovascular event.

Coronary events are defined as fatal or non-fatal acute coronary syndromes including myocardial infarction, or death due to ischemic heart disease.

Cardiovascular events are defined as fatal or non-fatal acute coronary syndromes including myocardial infarction, fatal or non-fatal stroke, or death due to cardiovascular disease.

In a preferred embodiment of the invention the method according to the invention is a method for predicting a first adverse event in a subject or identifying a subject having an enhanced risk for getting a first adverse event, wherein said adverse event is a coronary or cardiovascular event, especially preferred a coronary event.

In a preferred embodiment said subject is a subject with a low burden of traditional risk factors selected from but not restricted to the group comprising: cigarette smoking (defined as any smoking within the past year), diabetes, hyperlipidemia, hypertension, high body mass index (BMI) (i.e. preferably said subject has a BMI of below 30, preferably below 28, more preferably below 27, even more preferably below 26 and most preferably below 25), male gender, antihypertensive treatment, and age (the risk increases with age; preferably said subject has an age of below 55, preferably below 60, more preferably below 65, even more preferably below 70 and most preferably below 75).

In another preferred embodiment for all aspects of the invention said subject is “healthy” or “apparently healthy”.

“Healthy” or “apparently healthy”, as used herein, relates to individuals who have not previously had or alternatively are not aware of having had a cardiovascular or a coronary event or heart failure, and who are not having an acute infectious disease. Preferred, healthy or apparently healthy relates to individuals who have not previously had a cardiovascular or a coronary event or heart failure, and who are not having an acute infectious disease.

Thus, in a preferred embodiment of the invention, the “healthy” or “apparently healthy” subject is a subject who has not previously had or alternatively is not aware of having had a cardiovascular or a coronary event. It is further preferred that the “healthy” or “apparently healthy”. subject does not suffer from diabetes, and/or hypertension.

The apparently healthy subject may in a particular embodiment be suffering from diabetes, hyperlipidemia and/or hypertension. In this case the adverse event may not be selected from the group of diabetes, and/or hypertension. In one embodiment the apparently healthy subject is suffering from diabetes. In this case the adverse event is not diabetes.

In another embodiment, the healthy subject is suffering from hypertension. In this case the adverse event is not hypertension. Most preferably, the apparently healthy subject does not show any symptoms of any disease.

In one preferred embodiment, the adverse event is a coronary event and the “healthy” or “apparently healthy” subject may suffer from diabetes, hyperlipidemia and/or hypertension. In another preferred embodiment, the adverse event is a cardiovascular event and the “healthy” or “apparently healthy” subject may suffer from diabetes, hyperlipidemia and/or hypertension.

In a further preferred embodiment, the adverse event is a cardiovascular or a coronary event and the “healthy” or “apparently healthy” subject is suffering from diabetes. In another preferred embodiment the adverse event is a cardiovascular or a coronary event and the “healthy” or “apparently healthy” subject is suffering from hypertension.

In yet another preferred embodiment, the adverse event is myocardial infarction and the “healthy” or “apparently healthy” subject is suffering from diabetes, hyperlipidemia and/or hypertension. In a further preferred embodiment, the adverse event is myocardial infarction and the “healthy” or “apparently healthy” subject does not show any symptoms of any disease.

In yet another preferred embodiment, the adverse event is death due to ischemic heart disease and the “healthy” or “apparently healthy” subject is suffering from diabetes, hyperlipidemia and/or hypertension. In a further preferred embodiment, the adverse event is ischemic heart disease and the “healthy” or “apparently healthy” subject does not show any symptoms of any disease.

In general, however, in case the “healthy” or “apparently healthy” subject is suffering from a particular disease, the first adverse event according to the present invention and as defined herein cannot be this particular disease. E.g., if the “healthy” or “apparently healthy” subject is suffering from diabetes, the first adverse event as defined herein is not diabetes. If the apparently healthy subject is suffering from hypertension, the first adverse event as defined herein is not hypertension.

The subgroups of healthy and apparently healthy subjects are according to this invention the same subgroup of subjects as an apparently healthy person is a person which has not yet been diagnosed as having or having had an event or condition comprising the health of said subject which means that an apparently healthy person is a person which is considered to be healthy.

In one preferred embodiment of method of the invention said level of Pro-Adrenomedullin or fragments thereof is determined and used as single marker.

In another preferred embodiment of the invention the prediction of a first adverse event in a subject or the identification of a subject having an enhanced risk for getting a first adverse event is improved by additionally determining and using a laboratory parameter selected from the group comprising: CRP, LpLA2, Cystatin C and natriuretic peptides of the A- and the B-type as well as their precursors and fragments thereof including ANP, proANP, NT-proANP, MR-proANP, BNP, proBNP, NT-proBNP, triglycerides, HDL cholesterol or subfractions thereof, LDL cholesterol or subfractions thereof, GDF15, ST2, Procalcitonin and fragments thereof, Pro-Vasopressin and fragments thereof including copeptin, vasopressin and neurophysin, Pro-Endothelin-1 and fragments thereof including CT-proET-1, NT-proET-1, big-Endothelin-1 and Endothelin-1.

As mentioned herein in the context of CRP, LpLA2, Cystatin C and natriuretic peptides of the A- and the B-type as well as their precursors and fragments thereof including ANP, BNP, proANP, NT-proANP, MR-proANP, proBNP, NT-proBNP, GDF15, ST2, Procalcitonin or fragments thereof, Pro-Vasopressin and fragments thereof including copeptin, vasopressin and neurophysin, Pro-Endothelin-1 and fragments thereof including CT-proET-1, NT-proET-1, big-Endothelin-1 and Endothelin-1, these terms refer to either the entire molecule or fragments thereof of at least 12 amino acids.

The term “additionally determining” does not imply, albeit not exclude, that such determinations are technically combined. The term “additionally using” is defined as any kind of mathematical combination of parameters—be it laboratory and/or clinical parameters—that yield a description of a subject's risk to experience an adverse event or identifying a subject having an enhanced risk for getting an adverse event. One example of such mathematical combination is the Cox proportional hazards analysis, from which a subject's risk to experience an adverse event can be derived, but other methods maybe used as well.

The invention also involves comparing the level of marker for the individual with a predetermined value. The predetermined value can take a variety of forms. It can be single cut-off value, such as for instance a median or mean or the 75^{th}, 90^{th}, 95^{th} or 99^{th} percentile of a population. It can be established based upon comparative groups, such as where the risk in one defined group is double the risk in another defined group. It can be a range, for example, where the tested population is divided equally (or unequally) into groups, such as a low-risk group, a medium-risk group and a high-risk group, or into quartiles, the lowest quartile being individuals with the lowest risk and the highest quartile being individuals with the highest risk.

The predetermined value can vary among particular populations selected, depending on their habits, ethnicity, genetics etc. For example, a “healthy” or “apparently healthy”, non-smoker population (no detectable disease and no prior history of a cardiovascular disorder) might have a different ‘normal’ range of markers than a smoking population or a population the members of which have had a prior cardiovascular disorder. Accordingly, the predetermined values selected may take into account the category in which an individual falls. Appropriate ranges and categories can be selected with no more than routine experimentation by those of ordinary skill in the art.

The level of the above-mentioned marker can be obtained by any art recognized method. Typically, the level is determined by measuring the level or activity of the marker in a body fluid, for example, blood, lymph, saliva, urine and the like. The level can be determined by immunoassays or other conventional techniques for determining the level of the marker. Recognized methods include sending samples of a patient's body fluid to a commercial laboratory for measurement, but also performing the measurement at the point-of-care.

A specific combination of markers seems to be especially valuable for predicting an adverse event in a subject or identifying a subject having an enhanced risk for getting an adverse event.

Thus, in one aspect of the invention only the level of the following marker is determined and used: proBNP or fragments or precursors thereof having at least 12 amino acids, CRP, LpLA2 in combination with Pro-Adrenomedullin or fragments thereof. This specific combination seems to be especially valuable wherein a first cardiovascular event is predicted in a subject or a subject is identified having an enhanced risk for getting a first cardiovascular event.

Alternatively or additionally, determined levels of Pro-Adrenomedullin or fragments thereof maybe combined with clinical parameters. Thus, in another preferred embodiment of the invention the prediction of a first adverse event in a subject or the identification of a subject having an enhanced risk for getting a first adverse event is improved by determining and using clinical parameters, in addition to Pro-Adrenomedullin or fragments thereof, selected from the group: age, gender, systolic blood pressure, diastolic blood pressure, antihypertensive treatment, body mass index, presence of diabetes mellitus, current smoking.

In another preferred embodiment of the invention the prediction of an adverse event in a subject or the identification of a subject having an enhanced risk for getting an adverse event is improved by determining and using clinical and laboratory parameters e.g. biomarker, in addition to Pro-Adrenomedullin or fragments thereof, selected from the aforementioned groups.

In another aspect of the method according to the invention only the level of the following marker is determined and used: proBNP or fragments or precursors thereof having at least 12 amino acids in combination with Pro-Adrenomedullin or fragments thereof. This specific combination seems to be especially valuable wherein a coronary event is predicted in a subject or a subject is identified having an enhanced risk for getting a coronary event especially a first coronary event.

In a specific embodiment of the method according to the invention the use of said level of Pro-Adrenomedullin or fragments thereof comprises comparing said level of Pro-Adrenomedullin or fragments thereof to a threshold level, whereby, when said level of Pro-Adrenomedullin or fragments thereof exceeds said threshold level, a cardiovascular event or a first cardiovascular event is predicted in a subject or a subject having an enhanced risk for getting a (first) adverse event is identified.

Such threshold level can be obtained for instance from a Kaplan-Meier analysis (FIG. 6), where the occurrence of coronary events over time in the investigated population is depicted according to MR-proADM quartiles of the population. According to this analysis, subjects with MR-proADM levels above the 75^{th} percentile, that is above 0.52 nmol/L in the investigated population, have a significantly increased risk for getting a first adverse coronary event. This result is further supported by Cox regression analysis with full adjustment for classical risk factors: The highest MR-proADM quartile (all subjects with MR-proADM levels above 0.52 nmol/L) versus all other subjects is highly significantly associated with increased risk (HR=1.6 95% CI 1.2-2.2) for getting a first adverse coronary event.

Other preferred cut-off values are for instance the 90^{th}, 95^{th} or 99^{th} percentile of a normal population. By using a higher percentile than the 75^{th} percentile, one reduces the number of false positive subjects identified, but one might miss to identify subjects, who are at moderate, albeit still increased risk. Thus, one might adopt the cut-off value depending on whether it is considered more appropriate to identify most of the subjects at risk at the expense of also identifiying “false positives”, or whether it is considered more appropriate to identify mainly the subjects at high risk at the expense of missing several subjects at moderate risk.

Other mathematical possibilities to calculate an individual's risk by using the individual's MR-proADM value and other prognostic laboratory and clinical parameters are for instance the NRI (Net Reclassification Index) or the IDI (Integrated Discrimination Index). The indices can be calculated according to Pencina (Pencina M J, et al.: Evaluating the added predictive ability of a new marker: from area under the ROC curve to reclassification and beyond. Stat Med. 2008; 27:157-172).

Put simply, NRI (Net Reclassification Index) (based on CVD risk classes according to ATPIII risk algorithm, <10, 10-<20 and 20+% 10-year risk) calculates if—by adding for example MR-proADM to the model of classical risk factors—one moves a significant number of subjects who in fact had an event to a higher risk class and subjects who did not have an event to lower risk class. IDI (Integrated Discrimination Index), does a similar thing but ignores the borders of <10, 10-<20 and 20+% 10-year risk and instead calculates the “total integrated movement”, i.e. does addition of MR-proADM move subjects who had an event upwards on a continuous risk scale and subjects who did not have event downwards on the continuous risk scale.

NRI has clinical relevance as crossing the “magical border” of 20% means patient should be treated as a secondary preventive patient and thus means something to treatment (according to cardiology guidelines for prevention).

The present invention thus also pertains to a method for predicting the risk of getting an adverse event in a subject or identifying a subject having an enhanced risk for getting an adverse event according to any of the preceding claims, wherein the level of Pro-Adrenomedullin or fragments thereof either alone or in conjunction with other prognostically useful laboratory or clinical parameters is used for the prediction of a subject's risk for getting an adverse event by a method which may be selected from the following alternatives:
Comparison with the median of the level of Pro-Adrenomedullin or fragments thereof in an ensemble of pre-determined samples in a population of “healthy” or “apparently healthy” subjects,
Comparison with a quantile (e.g. the 75^{th}, 90^{th}, 95^{th} or 99^{th} percentile) of the level of Pro-Adrenomedullin or fragments thereof in an ensemble of pre-determined samples in a population of apparently healthy subjects,
Calculation based on Cox Proportional Hazards analysis or by using Risk index calculations such as the NRI (Net Reclassification Index) or the IDI (Integrated Discrimination Index).

In a preferred embodiment of the method according to the invention said sample is selected from the group comprising a blood sample, a serum sample, a plasma sample, and a urine sample or an extract of any of the aforementioned samples.

In another preferred embodiment of the invention the level of MR-proADM is measured. MR-proADM comprises amino acids 45-92 of Pre-Pro-ADM.

In another preferred embodiment of the invention the level of Pro-Adrenomedullin or fragments thereof is measured using a diagnostic assay using one or more capture probes directed against one ore more epitopes located in amino acid positions 45-92 of Pre-pro-ADM.

As mentioned herein, an “assay” or “diagnostic assay” can be of any type applied in the field of diagnostics. Such an assay may be based on the binding of an analyte to be detected to one or more capture probes with a certain affinity. Concerning the interaction between capture molecules and target molecules or molecules of interest, the affinity constant is preferably greater than 10⁸ M⁻¹.

In the context of the present invention, “capture molecules” are molecules which may be used to bind target molecules or molecules of interest, i.e. analytes, from a sample. Capture molecules must thus be shaped adequately, both spatially and in terms of surface features, such as surface charge, hydrophobicity, hydrophilicity, presence or absence of lewis donors and/or acceptors, to specifically bind the target molecules or molecules of interest. Hereby, the binding may for instance be mediated by ionic, van-der-Waals, pi-pi, sigma-pi, hydrophobic or hydrogen bond interactions or a combination of two or more of the aforementioned interactions between the capture molecules and the target molecules or molecules of interest. In the context of the present invention, capture molecules may for instance be selected from the group comprising a nucleic acid molecule, a carbohydrate molecule, a PNA molecule, a protein, an antibody, a peptide or a glycoprotein. Preferably, the capture molecules are antibodies, including fragments thereof with sufficient affinity to a target or molecule of interest, and including recombinant antibodies or recombinant antibody fragments, as well as chemically and/or biochemically modified derivatives of said antibodies or fragments derived from the variant chain with a length of at least 12 amino acids thereof.

The preferred detection methods comprise immunoassays in various formats such as for instance radioimmunoassays, chemiluminescence- and fluorescence-immunoassays, Enzyme-linked immunoassays (ELISA), Luminex-based bead arrays, protein microarray assays, and rapid test formats such as for instance immunochromatographic strip tests.

The assays can be homogenous or heterogeneous assays, competitive and non-competive sandwich assays. In a particularly preferred embodiment, the assay is in the form of a sandwich assay, which is a noncompetitive immunoassay, wherein the molecule to be detected and/or quantified is bound to a first antibody and to a second antibody. The first antibody may be bound to a solid phase, e.g. a bead, a surface of a well or other container, a chip or a strip, and the second antibody is an antibody which is labeled, e.g. with a dye, with a radioisotope, or a reactive or catalytically active moiety. The amount of labeled antibody bound to the analyte is then measured by an appropriate method. The general composition and procedures involved with “sandwich assays” are well-established and known to the skilled person. (The Immunoassay Handbook, Ed. David Wild, Elsevier LTD, Oxford; 3rd ed. (May 2005), ISBN-13: 978-0080445267; Hultschig C et al., Curr Opin Chem Biol. 2006 February; 10(1):4-10. PMID: 16376134), incorporated herein by reference.

In a particularly preferred embodiment the assay comprises two capture molecules, preferably antibodies which are both present as dispersions in a liquid reaction mixture, wherein a first marking component is attached to the first capture molecule, wherein said first marking component is part of a marking system based on fluorescence- or chemiluminescence-quenching or amplification, and a second marking component of said marking system is attached to the second capture molecule, so that upon binding of both capture molecules to the analyte a measurable signal is generated that allows for the detection of the formed sandwich complexes in the solution comprising the sample.

Even more preferred, said marking system comprises rare earth cryptates or rare earth chelates in combination with a fluorescence dye or chemiluminescence dye, in particular a dye of the cyanine type.

In the context of the present invention, fluorescence based assays comprise the use of dyes, which may for instance be selected from the group comprising FAM (5-or 6-carboxyfluorescein), VIC, NED, Fluorescein, Fluoresceinisothiocyanate (FITC), IRD-700/800, Cyanine dyes, auch as CY3, CY5, CY3.5, CY5.5, Cy7, Xanthen, 6-Carboxy-2′,4′,7′,4,7-hexachlorofluorescein (HEX), TET, 6-Carboxy-4′,5′-dichloro-2′,7′-dimethodyfluorescein (JOE), N,N,N′,N′-Tetramethyl-6-carboxyrhodamine (TAMRA), 6-Carboxy-X-rhodamine (ROX), 5-Carboxyrhodamine-6G (R6G5), 6-carboxyrhodamine-6G (RG6), Rhodamine, Rhodamine Green, Rhodamine Red, Rhodamine 110, BODIPY dyes, such as BODIPY TMR, Oregon Green, Coumarines such as Umbelliferone, Benzimides, such as Hoechst 33258; Phenanthridines, such as Texas Red, Yakima Yellow, Alexa Fluor, PET, Ethidiumbromide, Acridinium dyes, Carbazol dyes, Phenoxazine dyes, Porphyrine dyes, Polymethin dyes, and the like.

In the context of the present invention, chemiluminescence based assays comprise the use of dyes, based on the physical principles described for chemiluminescent materials in Kirk-Othmer, Encyclopedia of chemical technology, 4^{th} ed., executive editor, J. I. Kroschwitz; editor, M. Howe-Grant, John Wiley & Sons, 1993, vol. 15, p. 518-562, incorporated herein by reference, including citations on pages 551-562. Preferred chemiluminescent dyes are Acridiniumesters.

In an especially preferred embodiment a MR-proADM assay is used having a detection limit below 0.3 nmol/L and an interassay precision of <30% CV in the normal range for predicting a first adverse event in a subject or identifying a subject having an enhanced risk for getting a first adverse event.

Another embodiment of the present invention is the use of a capture probe, e.g. antibody directed against Pro-Adrenomedullin or fragments thereof for predicting a first adverse event in a subject or identifying a subject having an enhanced risk for getting a first adverse event.

Especially preferred in the context of the present invention is the use of one or more antibodies which are directed against an epitope included in the amino acids positions 45-92 of Pre-ProADM.

### EXAMPLES

The following examples outline the present invention in greater detail but shall not be understood as limiting the subject matter of the present invention.

Methods

Study Population

The Malmö Diet and Cancer (MDC) study is a community-based, prospective epidemiologic cohort of 28,449 persons enrolled between 1991 and 1996. From this cohort, 6,103 persons were randomly selected to participate in the MDC Cardiovascular Cohort, which was designed to investigate the epidemiology of atherosclerosis. Complete data on cardiovascular risk factors and plasma biomarkers were available on 4,707 subjects. After excluding participants with prevalent cardiovascular disease at baseline, there were 4,601 participants in the analysis of coronary events, and 4,483 participants in the analysis of all cardiovascular events.

Clinical Examination and Assays

All participants underwent a medical history, physical examination, and laboratory assessment of standard cardiovascular risk factors. Blood pressure was measured using a mercury sphyngomanometer after 10 minutes of rest in the supine position. Diabetes mellitus was defined as a fasting blood glucose greater than 6.0 mmol/L, a self-reported physician diagnosis of diabetes, or use of anti-diabetic medication. Cigarette smoking was elicited by a self-administered questionnaire, with current cigarette smoking defined as any smoking within the past year. We measured fasting total cholesterol, HDL cholesterol, and triglycerides according to standard procedures at the Department of Clinical Chemistry, University Hospital Malmö. LDL cholesterol was calculated according to Friedewald's formula.

All participants had assessment of cardiovascular biomarkers using fasting plasma specimens that had been frozen at −80° C. immediately after collection. C-reactive protein was measured by high-sensitivity assay (Tina-quant CRP, Roche Diagnostics, Basel, Switzerland). LpPLA2 activity was measured in duplicate using [3]M-platelet activating factor as substrate (Persson M, et al.: Elevated Lp-PLA2 levels add prognostic information to the metabolic syndrome on incidence of cardiovascular events among middle-aged nondiabetic subjects. Arterioscler Thromb Vasc Biol. 2007; 27:1411-1416). MR-proANP and MR-proADM were measured using immunoluminometric sandwich assays targeted against amino acids in the mid-regions of the respective peptide (BRAHMS, AG, Germany) (Morgenthaler N G, et al.: Immunoluminometric assay for the midregion of pro-atrial natriuretic peptide in human plasma. Clin Chem. 2004; 50:234-236; Morgenthaler N G, et al.: Measurement of midregional proadrenomedullin in plasma with an immunoluminometric assay. Clin Chem. 2005; 51:1823-1829). NT-proBNP was determined using the Dimension RxL N-BNP (Dade-Behring, Germany) (Di S F, et al.: Analytical evaluation of the Dade Behring Dimension RxL automated N-Terminal proBNP (NT-proBNP) method and comparison with the Roche Elecsys 2010. Clin Chem Lab Med. 2005; 43:1263-1273). Cystatin C was measured using a particle-enhanced immuno-nephelometric assay (N Latex Cystatin C, Dade Behring, Ill.) (Shlipak M G, et al.: Cystatin C and the risk of death and cardiovascular events among elderly persons. N Engl J Med. 2005; 352:2049-2060).

Clinical Endpoints

We examined two primary outcomes: coronary events and all cardiovascular events. The procedure for ascertaining outcome events has been detailed previously (Rosvall M, et al.: Incident coronary events and case fatality in relation to common carotid intima-media thickness. J Intern Med. 2005; 257:430-437; Rosvall M, et al.: Incidence of stroke is related to carotid IMT even in the absence of plaque. Atherosclerosis. 2005; 179:325-331). Coronary events were defined as fatal or non-fatal acute coronary syndromes including myocardial infarction, or death due to ischemic heart disease. All cardiovascular events were defined as fatal or non-fatal acute coronary syndromes including myocardial infarction, fatal or non-fatal stroke, or death due to cardiovascular disease. Events were identified through linkage of the 10-digit personal identification number of each Swedish citizen with two registries—the Swedish Hospital Discharge Register and the Swedish Cause of Death Register. Myocardial infarction was defined on the basis of International Classification of Diseases 9^{th} and 10^{th} Revisions (ICD9 and ICD10) codes 410 and I21, respectively. Death due to ischemic heart disease was defined on the basis of codes 412 and 414 (ICD9) or I22-I23 and I25 (ICD10) in the Swedish Cause of Death Register. Fatal or nonfatal stroke was using codes 430, 431 and 434 (ICD9). Classification of outcomes using these registries has been previously validated (Engstrom G, et al.: Geographic distribution of stroke incidence within an urban population: relations to socioeconomic circumstances and prevalence of cardiovascular risk factors. Stroke. 2001; 32:1098-1103). Follow-up for outcomes extended to Dec. 31, 2003.

Statistical Analyses

Continuous biomarker variables with skewed distributions were log-transformed before analysis. We performed multivariable Cox proportional hazards models to examine the association between biomarkers and incident events. We confirmed that the proportionality of hazards assumption was met. Hazards ratios were expressed per 1 SD increment in the respective biomarker. Each biomarker was individually tested against each endpoint with adjustment for traditional risk factors (age, sex, systolic blood pressure, diastolic blood pressure, use of anti-hypertensive therapy, current smoking, diabetes, LDL cholesterol, HDL cholesterol, and body mass index). Next, all of the biomarkers showing a significant relationship with the outcome were included in a backward elimination model, with the traditional risk factors forced in. P<0.05 was used as the criterion for retaining biomarkers in this model.

To assess model discrimination, we calculated the c-statistic for models with traditional risk factors with and without biomarkers. The c-statistic is a generalization of the area under the receiver-operating-characteristic curve (Pencina M J, et al.: Evaluating the added predictive ability of a new marker: from area under the ROC curve to reclassification and beyond. Stat Med. 2008; 27:157-172). We used the incidence of coronary or cardiovascular events at 10 years as the outcome. To assess global calibration of the risk models, we calculated Hosmer-Lemeshow statistics for models with and without biomarkers. Non-significant p-values for the Hosmer-Lemeshow statistic denote good agreement between predicted and observed event rates across deciles of predicted risk.

We also evaluated the ability of biomarkers to reclassify risk across National Cholesterol Education Program Adult Treatment Panel III (ATP3) risk categories, following methods suggested previously (Ridker P M, et al.: Development and validation of improved algorithms for the assessment of global cardiovascular risk in women: the Reynolds Risk Score. JAMA. 2007; 297:611-619; Pencina M J, et al.: Evaluating the added predictive ability of a new marker: from area under the ROC curve to reclassification and beyond. Stat Med. 2008; 27:157-172). Based on a traditional risk factor score, participants were initially classified as low, intermediate, or high risk if their predicted 10-year risk of a coronary event was <10%, 10% to <20%, or ≧20%, respectively. Participants were then allowed to be reclassified into different categories with the addition of the biomarker data. We assessed the number of participants reclassified, and also calculated the Net Reclassification Index (NRI) and Integrated Discrimination Index (IDI), as described by (Pencina M J, et al.: Evaluating the added predictive ability of a new marker: from area under the ROC curve to reclassification and beyond. Stat Med. 2008; 27:157-172). In the calculation of the NRI, individuals were considered accurately reclassified if they were reclassified to a higher category and subsequently developed a coronary event, or if they were reclassified to a lower category and remained event-free during follow-up. The IDI is an analogous measure of model performance, which improves when the risk model assigns higher probabilities to those who develop events and lower probabilities to those who remain event-free. In contrast to the NRI, the IDI is based on continuous probabilities, and thus improvement in the index does not rely on movement across risk category thresholds.

All analyses were performed using Stata software version 8.0 (StataCorp) except for the tests for the proportionality of hazards assumption which were performed using the survival package for R, and the c-statistics which were generated using the ROCR package for R (www.r-project.org). Tests were considered significant if the two-sided P-value was less than 0.05.

Results

Characteristics of the study sample are shown in Table 1. The mean age of the sample was 58 years.

Prediction of Cardiovascular Events Using Single Biomarkers

During a mean follow up of 10.6 years, first cardiovascular and first coronary events occurred in 288 and 169 participants, respectively. Results of Cox proportional hazards models for the association of individual biomarkers with cardiovascular events are shown in Table 2. After adjustment for traditional risk factors, 5 of 6 biomarkers (NT-proBNP, CRP, cystatin C, MR-proADM, LpPLA2) were significant predictors of incident cardiovascular events.

Several metrics were used to summarize the prognostic utility of adding individual biomarkers to classical risk factors (Table 2). A model based on classical risk factors had a c-statistic of 0.772, and the addition of individual biomarkers resulted in small increases in the c-statistic (<0.005). Models were well-calibrated, with Hosmer-Lemeshow p-values >0.05 whether or not biomarkers were included. Neither the NRI nor the IDI were significant for all biomarkers.

Prediction of Coronary Events Using Single Biomarkers

Results of Cox proportional hazards models for coronary events are shown in Table 3. When entered individually into a model with classical risk factors, 4 of the 6 biomarkers (NT-proBNP, MR-proANP, cystatin C, MR-proADM) were significant predictors of incident coronary events. Elevations in NT-proBNP and MR-proADM were associated with the highest hazards for coronary events, with adjusted hazards ratios per SD increment of 1.24 (95% confidence interval, 1.07-1.44) and 1.25 (95% confidence interval, 1.10-1.42), respectively.

The c-statistic associated with classical risk factors for predicting coronary events was 0.777. As with cardiovascular events, addition of individual biomarkers did not raise the c-statistic substantially (Table 3). Model calibration was good (Hosmer-Lemeshow p>0.05) with or without biomarkers, and the NRI was non-significant. The IDI was significant for MR-proADM (p=0.02), and borderline significant for NT-proBNP (p=0.05).

Multiple Biomarkers for Cardiovascular and Coronary Events

Combinations of biomarkers were tested by entering the biomarkers as a set into prediction models for cardiovascular events and coronary events. Stepwise backward elimination was then used to remove less informative biomarkers, using p<0.05 as the criteria for retention. Three biomarkers were retained for prediction of cardiovascular events (NT-proBNP, CRP, and LpPLA2), and 2 biomarkers were retained for prediction of coronary events (NT-proBNP and MR-proADM). Results of multivariable Cox proportional hazards models are shown in Table 4, for both outcomes. Incorporation of the set of significant biomarkers into prediction models for cardiovascular and coronary events led to small increments (approximately 0.01) in the c-statistics. The NRI was not significant for either outcome. On the other hand, the IDI had p-values of 0.06 for cardiovascular events and 0.02 for coronary events.

Tables 5 shows the number of participants reclassified using biomarkers for cardiovascular events (Panel A) and coronary events (Panel B), respectively. For cardiovascular events, use of biomarkers moved 273 participants (6%) into a higher or lower risk category. Only 39 partcipants (0.8%) were moved into the high risk category (10-year predicted risk ≧20%). For coronary events, 137 (3%) participants were reclassified into a higher or lower risk category, with only 22 (0.5%) moved into the high risk category.

Simple biomarker risk scores were constructed for each endpoint. Beta coefficients for the 3 biomarkers predicting cardiovascular events were similar in magnitude, as were the beta coefficients for the 2 biomarkers predicting coronary events. Thus, we elected to weight each of the biomarkers equally in the biomarker risk scores. For cardiovascular disease, each participant was assigned a score of 0, 1, 2, or 3, corresponding to the number of biomarkers that were elevated, defined as having a level more than 1 SD above the mean. In a similar fashion, each participant was assigned a score of 0, 1, or 2 for coronary events. FIG. 6 depicts the cumulative incidence of cardiovascular (Panel A) or coronary (Panel B) events, according to values of the biomarker risk scores.

TABLE 1
Characteristics of the study sample (n = 4,601)

| Clinical variable | |
|---|---|
| Age, years | 58 ± 6 |
| Male gender, % | 40 |
| Systolic blood pressure, mm Hg | 141 ± 19 |
| Diastolic blood pressure, mm Hg | 87 ± 9 |
| Antihypertensive treatment, % | 16 |
| Body mass index, kg/m² | 25.7 ± 3.9 |
| LDL cholesterol, mmol/L | 4.2 ± 1.0 |
| HDL cholesterol, mmol/L | 1.4 ± 0.4 |
| Diabetes mellitus, % | 8 |
| Current smoking, % | 27 |
| MR-proADM, nmol/L | 0.46 ± 0.13 |
| MR-proANP, pmol/L | 66 (51-86) |
| NT-proBNP, pg/mL | 61 (34-110) |
| Cystatin C, mg/L | 0.78 ± 0.15 |
| CRP, mg/L | 1.3 (0.7-2.7) |
| LpPLA2 activity, nmol/min/mL | 44 (36-52) |

Normally distributed data are given as mean ± SD, skewed variables are given as median (IQR).

TABLE 2
Individual biomarkers and incident
cardiovascular events (n = 4,481)

| | Adjusted | | | | | |
|---|---|---|---|---|---|---|
| Biomarker | HR | 95% CI | P | Δ C* | P_{NRI}† | P_{IDI}† |
| NT-proBNP | 1.18 | (1.05-1.33) | 0.007 | 0.004 | 0.21 | 0.06 |
| MR- | 1.14 | (1.02-1.27) | 0.01 | 0.004 | 0.91 | 0.19 |
| proADM | | | | | | |
| MR-proANP | 1.12 | (0.99-1.26) | 0.06 | 0.001 | 0.78 | 0.26 |
| Cystatin C | 1.12 | (1.02-1.24) | 0.01 | 0.004 | 0.52 | 0.44 |
| LpPLA2 | 1.14 | (1.005-1.30) | 0.04 | 0.003 | 0.68 | 0.51 |
| CRP | 1.19 | (1.05-1.34) | 0.005 | 0.004 | 0.92 | 0.43 |

All hazards ratios are expressed per SD increment in biomarker concentration. Multivariable Cox proportional hazards models were adjusted for age, sex, antihypertensive treatment, systolic blood pressure, diastolic blood pressure, body mass index, diabetes, LDL, HDL, and current smoking. *Increment in C-statistic in a model with classical risk factors and the biomarker, compared with a classical risk factors alone (C=0.772). †P-value for increase in Net Reclassification Index (NRI) or integrated discrimination index (IDI) in a model with classical risk factors and the biomarker, compared with classical risk factors alone. CI, confidence interval; HR, hazards ratio.

TABLE 3
Individual biomarkers and incident coronary events (n = 4,601)

| | Adjusted | | | | | |
|---|---|---|---|---|---|---|
| Biomarker | HR | 95% CI | P | Δ C* | P_{NRI}† | P_{IDI}† |
| NT-proBNP | 1.24 | (1.07-1.44) | 0.005 | 0.004 | 0.70 | 0.05 |
| MR- | 1.25 | (1.10-1.42) | <0.001 | 0.005 | 0.43 | 0.02 |
| proADM | | | | | | |
| MR-proANP | 1.21 | (1.04-1.41) | 0.01 | 0.0001 | 0.42 | 0.12 |
| Cystatin C | 1.15 | (1.05-1.28) | 0.005 | 0.004 | 0.55 | 0.30 |
| LpPLA2 | 1.07 | (0.91-1.26) | 0.31 | NA | NA | NA |
| CRP | 1.12 | (0.96-1.31) | 0.17 | NA | NA | NA |

All hazards ratios are expressed per SD increment in biomarker concentration. Multivariable Cox proportional hazards models were adjusted for age, sex, antihypertensive treatment, systolic blood pressure, diastolic blood pressure, body mass index, diabetes, LDL, HDL, and current smoking. *Increment in C-statistic in a model with classical risk factors and the biomarker, compared with a classical risk factors alone (C=0.777). †P-value for increase in Net Classification Index (NRI) or integrated discrimination index (IDI) in a model with classical risk factors and the biomarker, compared with classical risk factors alone. CI, confidence interval; HR, hazards ratio; NA, not analysed.

TABLE 4
Multiple biomarkers and incident cardiovascular
and coronary events

| | | | | | | |
|---|---|---|---|---|---|---|
| Biomarkers | | | | | | |
| retained | | | | | | |
| by backwards | Adjusted | | | | | |
| elimination | HR | 95% CI | P | Δ C* | P_{NRI}† | P_{IDI}† |

First cardiovascular events

| | | | | | | |
|---|---|---|---|---|---|---|
| NT-proBNP | 1.16 | (1.03-1.30) | 0.017 | 0.008 | 0.13 | 0.06 |
| CRP | 1.18 | (1.03-1.33) | 0.008 | | | |
| LpPLA2 | 1.15 | (1.01-1.30) | 0.03 | | | |

First coronary events

| | | | | | | |
|---|---|---|---|---|---|---|
| NT-proBNP | 1.19 | (1.02-1.38) | 0.03 | 0.009 | 0.28 | 0.02 |
| MR-proADM | 1.21 | (1.06-1.38) | 0.004 | | | |

All hazards ratios are expressed per SD increment in biomarker concentration. Multivariable Cox proportional hazards models were adjusted for age, sex, antihypertensive treatment, systolic blood pressure, diastolic blood pressure, body mass index, diabetes, LDL, HDL, and current smoking. For each endpoint, all biomarkers shown were entered together into the Cox model. *Increment in C-statistic in a model with classical risk factors and the biomarker set. †P-value for increase in Net Classification Index (NRI) or integrated discrimination index (IDI) in a model with classical risk factors and the biomarker set, compared with classical risk factors alone. CI, confidence interval; HR, hazards ratio.

TABLE 5
Reclassification of participants with addition of biomarkers
to traditional cardiovascular risk factors

| Model with traditional | Model with traditional risk factors and biomarkers | | | |
|---|---|---|---|---|
| risk factors alone | <10% | 10% to <20% | ≧20% | Total |

Panel A: Cardiovascular Events

| | | | | |
|---|---|---|---|---|
| <10% | 3,728 | 103 | 1 | 3,832 |
| 10% to <20% | 99 | 344 | 38 | 481 |
| ≧>20% | 0 | 32 | 138 | 170 |
| Total | 3,827 | 479 | 177 | 4,483 |

Panel B: Coronary Events

| | | | | |
|---|---|---|---|---|
| <10% | 4,265 | 52 | 0 | 4,317 |
| 10% to <20% | 52 | 165 | 22 | 239 |
| ≧20% | 0 | 11 | 34 | 45 |
| Total | 4,317 | 228 | 56 | 4,601 |

### DESCRIPTION OF DRAWINGS

FIG. 1: Amino acid sequence of the adrenomedullin (ADM) precursor peptide (pre-pro-ADM). Amino acids 1-21 form a signal peptide Amino acids 22-41 form the pro-ADM N-20 terminal peptide (pro-ADM N20)). Amino acids 45-92 form the MR-proADM peptide. Mature ADM comprises amino acids 95-146. Amino acids 148-185 form the pro-ADM C-terminal fragment.

FIG. 2: Amino acid sequence of the pro-adrenomedullin peptide (pro-ADM).

FIG. 3: Amino acid sequence of the pro-adrenomedullin N-terminal 20 peptide (pro-ADM N20; PAMP). The PAMP peptide may have an amidated C-term.

FIG. 4: Amino acid sequence of the MR pro-adrenomedullin (MR-pro-ADM).

FIG. 5: Amino acid sequence of the mature adrenomedullin peptide (ADM). ADM peptide may have an amidated C-term and/or may be glycosylated.

FIG. 6: Kaplan-Meier-Plot for coronary events of the investigated population grouped in MR-proADM quartiles.

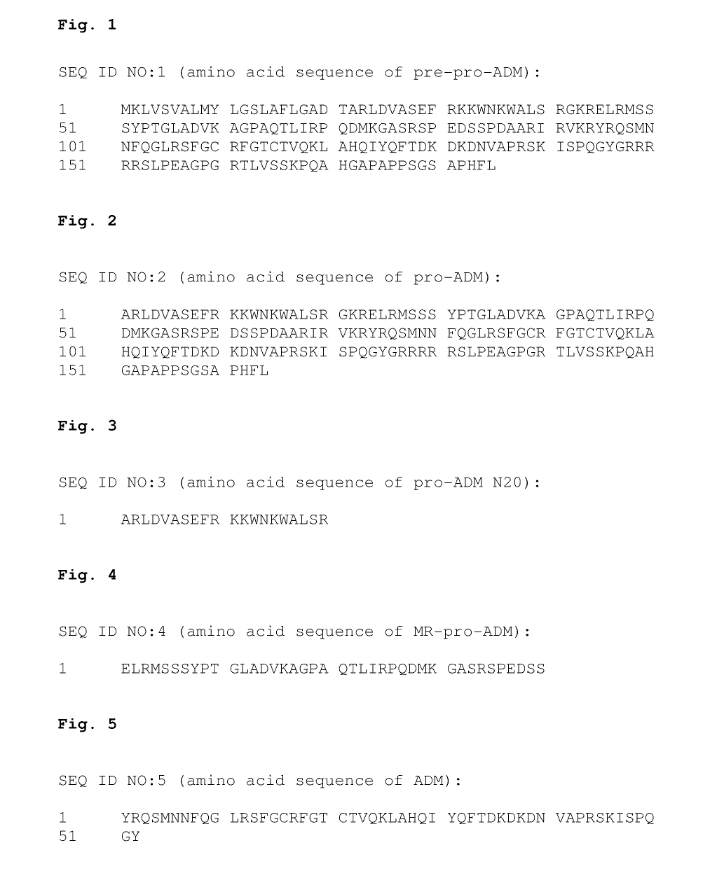

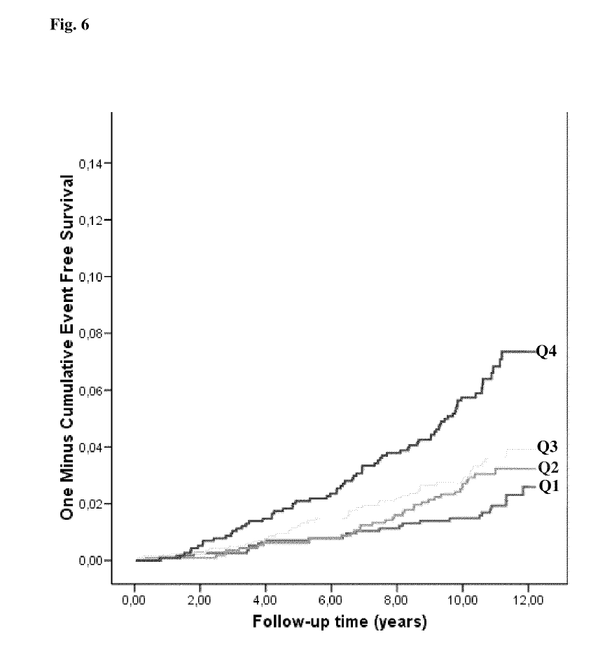

1. A method for predicting the risk of getting a adverse event in a healthy subject or identifying a healthy subject having an enhanced risk for getting an adverse event comprising:
determining the level of Pro-Adrenomedullin or fragments thereof of at least 12 amino acids in a sample obtained from said subject; and
using said level of Pro-Adrenomedullin or fragments thereof for the prediction of a first adverse event or inferring from it a risk for getting a first adverse event, wherein the subject is healthy.

2. A method according to claim 1, wherein said adverse event is a coronary or cardiovascular event.

3. A method according to claim 1, wherein the subject is a subject with a low burden of traditional risk factors selected from the group comprising:
cigarette smoking, diabetes, hyperlipidemia, hypertension, high body mass index, male gender, antihypertensive treatment, and age.

4. A method according to claim 1, wherein the level of Pro-Adrenomedullin or fragments thereof is determined and used as single marker.

5. A method according to claim 1, wherein the prediction of a first adverse event in a subject or the identification of a subject having an enhanced risk for getting a first adverse event is improved by additionally determining and using the level of at least one further marker selected from the group comprising: CRP, LpLA2, Cystatin C and natriuretic peptides of the A- and the B-type as well as their precursors and fragments thereof including ANP, proANP, NT-proANP, MR-proANP, BNP, proBNP, NT-proBNP triglycerides, HDL cholesterol or subfractions thereof, LDL cholesterol or subfractions thereof, GDF15, ST2, Procalcitonin and fragments thereof, Pro-Vasopressin and fragments thereof including copeptin, vasopressin and neurophysin, Pro-Endothelin-1 and fragments thereof including CT-proET-1, NT-proET-1, big-Endothelin-1 and Endothelin-1.

6. A method according to claim 5 wherein only the level of the following marker is determined and used: proBNP or fragments or precursors thereof having at least 12 amino acids, CRP, LpLA2 in combination with Pro-Adrenomedullin or fragments thereof.

7. A method according to claim 6, wherein a first cardiovascular event is predicted in a subject or a subject is identified having an enhanced risk for getting a first cardiovascular event.

8. A method according to claim 5 wherein only the level of the following marker is determined and used: proBNP or fragments or precursors thereof having at least 12 amino acids in combination with Pro-Adrenomedullin or fragments thereof of at least 12 amino acids.

9. A method according to claim 8, wherein a first coronary event is predicted in a subject or a subject is identified having an enhanced risk for getting a first coronary event.

10. A method according to claim 1, wherein, additionally at least one clinical parameter is determined selected from the group comprising: age, gender, systolic blood pressure, diastolic blood pressure, antihypertensive treatment, body mass index, presence of diabetes mellitus, current smoking.

11. A method for predicting the risk of getting an adverse event in a subject or identifying a subject having an enhanced risk for getting an adverse event according to any of the preceding claims, wherein the level of Pro-Adrenomedullin or fragments thereof either alone or in conjunction with other prognostically useful laboratory or clinical parameters is used for the prediction of a subject's risk for getting an adverse event by a method which may be selected from the following alternatives:
Comparison with the median of the level of Pro-Adrenomedullin or fragments thereof in an ensemble of pre-determined samples in a population of “healthy” or “apparently healthy” subjects,
Comparison with a quantile of the level of Pro-Adrenomedullin or fragments thereof in an ensemble of pre-determined samples in a population of “healthy” or “apparently healthy” subjects,
Calculation based on Cox Proportional Hazards analysis or by using Risk index calculations such as the NRI (Net Reclassification Index) or the IDI (Integrated Discrimination Index).

12. A method according to claim 1, wherein the level of MR-proADM is measured using a diagnostic assays comprising one or more capture probes directed against one ore more epitopes located in amino acid positions 45-92 of Pre-pro-ADM.

13. Use of an MR-proADM assay having a detection limit below 0.3 nmol/L and/or below the median of a population of healthy subjects and an interassay precision of <30% CV in the normal range for predicting an adverse event in a subject or identifying a subject having an enhanced risk for getting an adverse event.

14. Use of a capture probe directed against Pro-Adrenomedullin or fragments thereof for predicting an adverse event in a subject or identifying a subject having an enhanced risk for getting an adverse event.

15. Use according to claim 14 wherein the capture probes are directed against one ore more epitopes located in amino acid positions 45-92 of Pre-pro-ADM.
